(19) United States
(12) Patent Application Publication
(10) Pub. No.: US 2012/0204029 A1
(43) Pub. Date: Aug. 9, 2012

(54) METHOD AND SYSTEM FOR CONDUCTING AN ATTORNEY CLIENT PRIVILEGED CONFERENCE WITH THE LAWYER AT AN INDEPENDENT LOCATION

(76) Inventor: Slade Culli Trabucco, Wilmington, NC (US)

(21) Appl. No.: 13/020,919

(22) Filed: Feb. 4, 2011

(51) Int. Cl. G06F 15/16; H04L 9/32

(52) U.S. Cl. 713/168; 709/227

(57) ABSTRACT

The present invention relates to a secure system for video conference between an attorney and their incarcerated inmate client. Client is positioned at a video conference terminal and attorney at their computer and the conference scheduled, confirmed and completed over the internet in a secure manner.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a video conference method and system involving inmates and their attorney's. In particular, the present invention relates to a video conference system that allows secure video conferencing when the attorney is not in the courtroom yet still preserves attorney-client privilege.

2. Description of Related Art

The concept of video conferencing is not new and there are many systems developed for such conferences. The increased speed of computers and the availability of the internet has allowed for video conferencing that is fast and easy. Companies like Skype provide this kind of service which is now available at little or no cost to most people. However, such video conferencing is not secure from hacking, and like a phone, anyone with access to the computer can make a call.

It has been the case that the conveniences offered by video conferencing as well as the safety involved has facilitated their use in communication between courthouses and jails. Video conferencing has been increasingly relied on for such things as arraignment proceedings or other active court proceedings. An arraignment or other court proceeding, for example, typically involves the judge, a clerk, the inmate, the lawyers, and the like, and the inmate can be viewed or talked to during this period. The security of attorney client privilege is assured by providing private viewing and by the appearance of the lawyer in front of the Judge with the court controlling access of the lawyer to the video conferencing.

Several video conferencing systems for use in the courtroom have been developed and many patented. In U.S. Pat. No. 7,061,521 there is a video conferencing system that connects a courtroom with the jail. The system enables the private communication between the attorney and his inmate client in confidence. It essentially works by establishing a point-to-point link between a courtroom and a jail. The parties must be available at both locations. While this is usually not a problem for the incarcerated client, the attorney is limited to the courtroom location.

Prior to and in-between court proceedings it is necessary for the attorney to have conversations with the client. Those must be confidential and only the attorney or firm representing the inmate should be allowed access to the inmate. While video conferencing works well when the attorney is in the presence of the court, there is a need for a secure and verifiable method for dealing with video conferencing with an incarcerated inmate when the attorney is in his office or other location outside the jail that is secure and allows for an attorney-client privileged conversation and exchange of information.

### BRIEF SUMMARY OF THE INVENTION

The present invention relates to a system and method which addresses the problems of the prior art in a novel and useful way. More specifically, the present invention relates to a system and method for securely having conversations between an incarcerated inmate and a lawyer at any other location over a secure channel wherein the attorney is verified, the video conference is secure, and the jail can control the conversation time and location for the inmate.

In one embodiment the present invention relates to a method for conducting a confidential privileged video conference at a selected time between an incarcerated inmate at a specific video conference terminal at the incarceration location and the inmate's attorney located at a computer at an independent location comprising:
a) establishing a server to securely link the conference terminal and the computer over a communication network;
b) verifying the lawyer's status and identity;
c) verifying the inmate is the attorney's client;
d) assigning an identity code for the attorney to sign into the server using the computer over the communication network;
e) establishing one or more people responsible to bring the inmate to the conference terminal at the selected time;
f) the attorney signing into the server while the inmate is brought to the terminal by the one or more people at the selected time;
g) the server establishing an encrypted link between the terminal and the computer at the selected time; and
h) the attorney and inmate conducting a confidential video conference.

In yet another embodiment the present invention relates to a system for conducting a confidential privileged video conference between an inmate incarcerated at a specific incarceration location and a verified attorney at a computer positioned at an independent location comprising:
a) a video conference terminal at the specific incarceration location;
b) a first server connected to a communications network designed to provide encrypted communication between the video conference terminal and the computer;
c) a verification service on a second server for communicating with the attorney on the computer; verifying the attorney and connecting the computer to the video conference terminal via the first server;
d) a scheduling service on a third server comprising a database of available conference times, a network interface for selecting a date and time for the video conference and a timer for starting the teleconference; and
e) a system for notifying at least one selected person at the incarceration location of the date and time of the conference for the purpose of bringing the inmate to the video conference terminal to participate in the conference.

In still another embodiment of the present invention there is a method for verifying an attorney for participating in a confidential privileged video conference between an incarcerated inmate at a video conference terminal at an incarceration location and the attorney at a computer located at an independent location comprising:
a) assembling an encrypted video conference system between the terminal and the computer;
b) assigning an attendant to manage the attorney verification;
c) the attorney providing proof of attorney status, proof of identity and proof that the inmate is the attorney's client to the attendant; and
d) the attendant issuing an access code to the attorney for accessing the encrypted video conference system.

### BRIEF DESCRIPTION OF THE DRAWINGS

FIG. 1 is a flow chart of the invention detailing the process of having a video conference.

FIG. 2 is a flow chart of the process of setting up and having a conference.

FIG. 3 is a relationship chart of the system of the present invention for multiple attorneys, jails, and inmates.

FIG. 4 is the relationship and function of the server of the present invention.

FIG. 5 is a detailed view of the server function.

FIG. 6 is a relationship chart of the process of verifying the attorney.

FIG. 7 is a block diagram of multiple servers.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the phrase “confidential privileged video conference” refers to a video conference that is between an attorney and their client and is conducted in a manner to preserve the attorney/client privilege. The video conference, as detailed in the specification and claimed herein, relates to conducting a video conference over a communication network, for example, over the internet or any similar network in a secured manner.

A conference can be scheduled by logging into a server over the web connection of the system. The times available for the conference are selected from available dates and times that the jail has. This process engages the process of notifying the incarcerating location (e.g. jail) for transporting the inmate to the conference terminal.

As used herein “selected time” refers to a time wherein the participants in the video conference have selected to meet for the video conference. In the present system, the selected time available is determined by the incarceration location. This corresponds to when the incarceration location will make the inmate available for meetings of any kind, or specifically, for conferences with their attorney. Normally, the video conference will be for a specific length of time in order to be able to schedule other video conferencing at the same conference terminal. However, an uncertain ending time could be utilized or a no later than ending time could be utilized. In order to coordinate the time within the incarceration location, the start time must be agreed upon and that is accomplished herein by the method operator gathering the available times from the incarceration location and putting the times on the server so that when the attorney signs into the method system, the attorney can select a start time by entering an available time or selecting from a list of available times or the like and in several embodiments select a stop time or agree to a limited time or the like.

As used herein “incarcerated inmate” is the client of an attorney who is in jail or other like facility called the incarceration location. The incarcerated inmate's attorney is located at a computer anywhere for accessing the communication network which is located at a location independent of the conference terminal.

An “independent location” refers to any location away from the conference terminal and having communication network access. Examples of such locations would be the attorney's law firm location, the attorney's home, or any private location where absent the present system, the identity of the attorney would be difficult or impossible to confirm.

A conference can be initiated automatically or can be enabled by the attorney. In one embodiment the attorney logs into the system which upon entry of identity code, is connected to the conference. In other embodiments the conference starts and/or ends automatically or the like.

As used herein “conference terminal” is a secure location within the incarceration location or under the control of the incarceration location where there is a terminal (computer and monitor) for accessing the communication network utilizing a video camera, such as a web cam, microphone, or speaker, and engaging in a video conference. This location can be a computer with an internet hook-up and a web cam, or similar set up. In order to insure privileged secure communication, the location will be secure and unmonitored to the extent that conversations cannot be overheard or otherwise observed at the incarceration location. This can be accomplished with an isolated room with windows for observing the inmate without listening, an isolated area, or the like. Another method is to utilize a kiosk. Sound proofing or the like can be used to further security. The computer can be a standard computer but in one embodiment, it is set up to only be able to engage in the video conference and set up to be incapable of recording the video conference or any other function so that other conferences cannot be had, nor someone accidentally or on purpose record a video conference improperly, thus breaching attorney/client privilege. In addition, in one embodiment, the conference can only be initiated from the attorney's computer and not the conference terminal. While these kinds of restrictions would be placed on the inmate terminal no such retractions would be placed on the attorney's computer and location, thus the attorney would be responsible for recordings and isolating the attorney's end of the conference as desired.

In the present invention, a “server” is one or more computers having an application and connected to the communicating network. A server is utilized as the go-between for the attorney and inmate in setting up a video conference with the server operating over the internet. A server, or the equivalent computer, is in a link over a communication network, such as the internet. It is set up such that the conference referee or link between the attorney and client is the server. Both the attorney and client have computers/terminals which give them access to the network, and thus the server and the entire video conference occurs through this server which acts to control the confidentiality of the parties as well as the identity of the parties. One first server can be used for the verification/registration/payment process and another second server for the video conference software. Yet another server can be used to sign in for the video conference. In one embodiment all functions are on a single server.

The server can have the video conference software as well as identifying codes of the parties to the conference. Further identifying software, such as thumbprint identification software, facial recognition, or the like, can be utilized to make sure the correct parties to the confidential video conference are attending the conference at each end. In addition, face recognition software could be utilized to make sure no unauthorized personal are within the view of the video camera on each side of the conference. The server also acts as the link to sign up and schedule video conferences, and to notify the jail or other inmate incarceration location to the time of the conference and a list of their inmates. Further, the sever can be used not only to verify identity, it can be used to link an attorney to one or more clients at the incarceration location.

In one embodiment, one or more people at the incarceration location are established as the person responsible for bringing the inmate to the conference terminal at a selected time and/or to approve selected dates and times for a conference. Therefore, after the server links to a schedule and schedules a conference, the jail is notified and places on their schedule when to bring one or more inmates to the video conference terminal at the incarceration location for the video conference at the selected time.

By passing the video conference through a server, an encrypted link to the conference can be established. Confidential links are in the skill of the art and combined with the party ID on both sides and the conference set up, establishes the unique conferencing system of the present invention. As an example of a conferencing software Windows Live Meeting can be utilized with a present system.

Once the attorney and inmate are at their respective terminals/computers, the attorney begins by signing into the server via a GUI that accepts an identity code (a number, thumb print, face recognition, etc.). At the same time the incarceration location brings the inmate to the conference terminal and is responsible for the identity of the person at that end. In one embodiment, the inmate is given a code to sign in with or is otherwise identified by fingerprint, face recognition, or the like, thus verifying not only the attorney at the beginning of the conference but the system verifies the inmate as well. It is another embodiment of the present invention that the incarceration location is responsible for the identification of the inmate.

The server, once programmed with the time for the conference, can be programmed such that the conference can only begin at a particular time or starts automatically at a particular time, thus insuring control over the schedule for all inmates using the system. Likewise, where a precise end time to the conference is desired, the conference can be programmed to stop the conference automatically at a particular time. Normally, in a manual situation in one embodiment, only the attorney can end the conference because the conference terminal has no means for the inmate to operate the terminal, i.e. the inmate cannot operate the computer at the terminal in anyway.

One safety feature that is an embodiment of the present invention is where the conference terminal is only designed, programmed, or outfit with software such that while it is capable of connecting to the network such as the internet, it can only serve to be used as the video conference terminal, thus preventing unwanted internet connections by an inmate. Another safety feature is the system can be configured such that it excludes from operation any other device in the system that is not approved other than the attorney's computer and the conference terminal. Once again, recording could be limited to just the attorney's computer for further confidentiality under the system of the present invention.

In the process of verifying the attorney for participation in a confidential privileged video conference between an incarcerated inmate at their video conference terminal at the incarceration location and the attorney at a computer terminal located at an independent location, at least one person of the system is assigned to the process of attorney verification. The system must not only verify the identity of the person who is representing the client, i.e. the attorney by photo ID or the like, the system also needs to verify that the person is an attorney in good standing with the local or other appropriate bar for the particular inmate. The attorney provides proof of attorney status, such as a state bar attorney registration card, a letter of good standing from a local bar, or the like. The attorney also provides attorney verification that they are indeed the attorney who is in good standing. It is also important that the attorney prove that there is an attorney client relationship, such as a non confidential agreement, between the parties, a verified letter or acknowledgement from the attorney or similar proof. The one or more attendant managing the process can then approve the attorney and issue the appropriate access code to the attorney for accessing the video conference system of the present invention. The access code can be one code for the attorney used for all conferences and all inmates. It can also be a code issued for each conference or one code for each of the attorney's clients as desired. The more levels of confidentiality, the less likely an error would occur if at all.

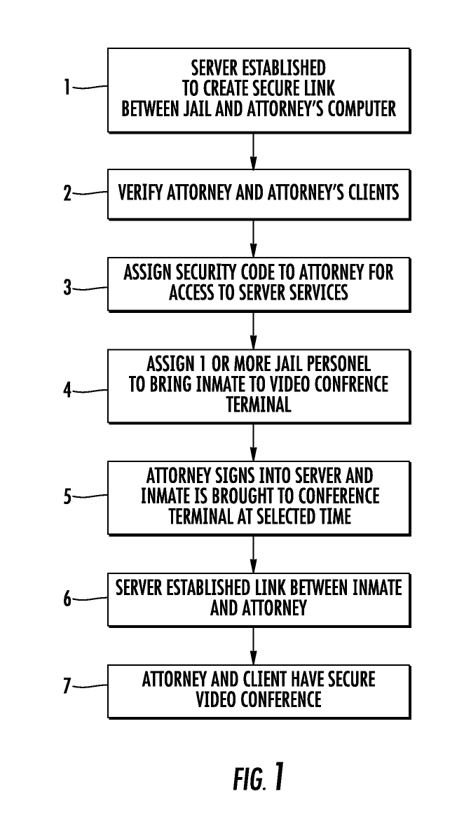

Now referring to the drawings. FIG. 1 is a flow chart of an embodiment of the process of having a video conference. It should be noted that all flow charts are exemplary and individual process steps can be in any order that achieves the proper goal of a video conference. In this embodiment, the server is established to create a secure link (such as an encrypted link) between a jail (at a conference terminal) and an attorney's computer 1 (located at an independent location). The attorney and attorney's client is verified 2 such that the system knows that the right parties are participating and the attorney is properly licensed. The attorney is assigned one or more security codes to access the server and its services over the network 3 (internet). Next one or more jail personnel at each jail location is assigned to make sure the inmate is brought to the conference terminal at the appropriate date and time 4. At the same time as the inmate is sitting at the conference terminal, the attorney signs into the server 5. Next, the server establishes a link between the inmate and the attorney 6 and the attorney and the attorney's client have a secure video conference 7.

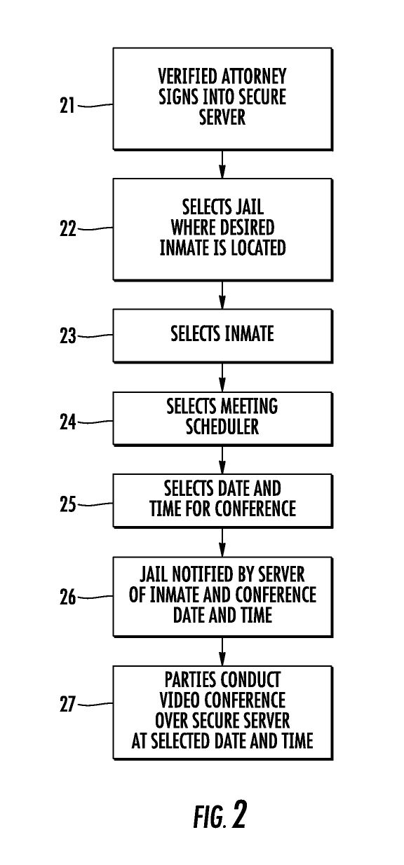

In FIG. 2 there is disclosed a flow chart of the method wherein a video conference is set up by the present invention. The verified attorney signs into the server 21 using a code assigned to either the attorney, the particular conference, or for the inmate. Then, the attorney, from a GUI on the internet connected to the server, selects the jail where the desired inmate is located 22 that the attorney wishes to have a video conference with. The attorney selects the inmate 23. Next, the attorney selects a meeting scheduler 24 which gives the attorney available days and times available for a video conference 25 and selects an appropriate conference schedule. Once the attorney has selected the date and time 25, the jail is notified by the server or other means of the date and time of the conference 26 so that the jail can put the transfer of the inmate on its schedule. Lastly, once scheduled, the parties (attorney and inmate) can have a video conference as taught herein 27.

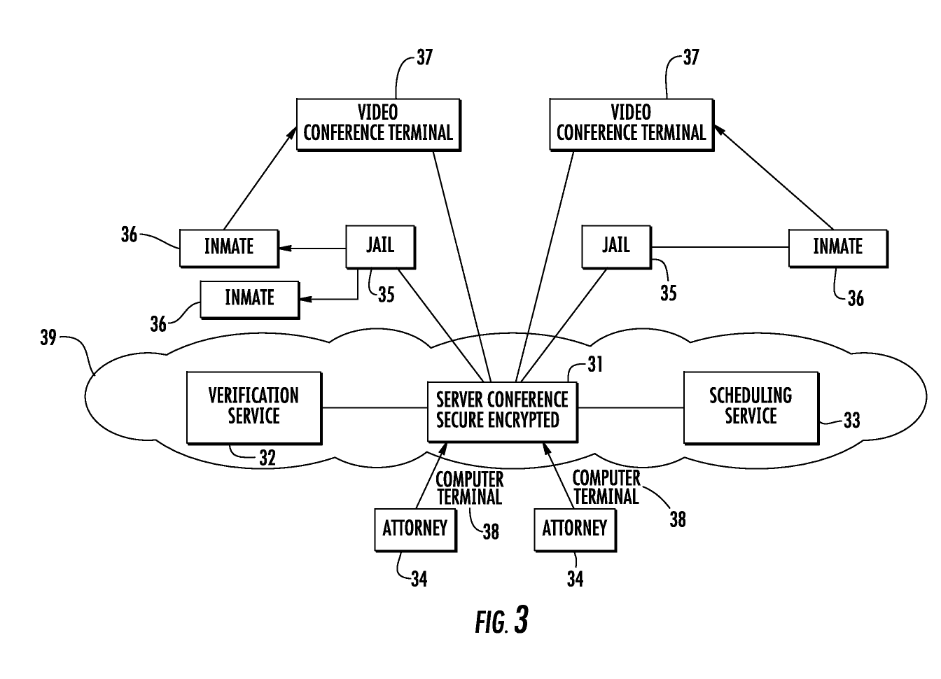

In FIG. 3 there is shown an example of the system of the invention with multiple jails, inmates, and attorneys depicted. In this view an encrypted secure server 31 is positioned to provide service over the internet 39. The server comprises of conference service, a verification service 32, and a scheduling service 33. While the server 31 could consist of essentially only these functions, in another embodiment it comprises other functions. The attorneys 34 can access the server 31 via their computer terminals 38 which are positioned at an independent location. The server 31 is connected to the jail 35 and the video conference terminal 37 via an internet 39 connection to the server 31. This connection is utilized for the video conferencing, for notifying the jail of which inmate is conferencing, and what date and time the conference going on so that inmates 36 will be brought to the conference terminal at the appropriate date and time and some inmates left in their cells.

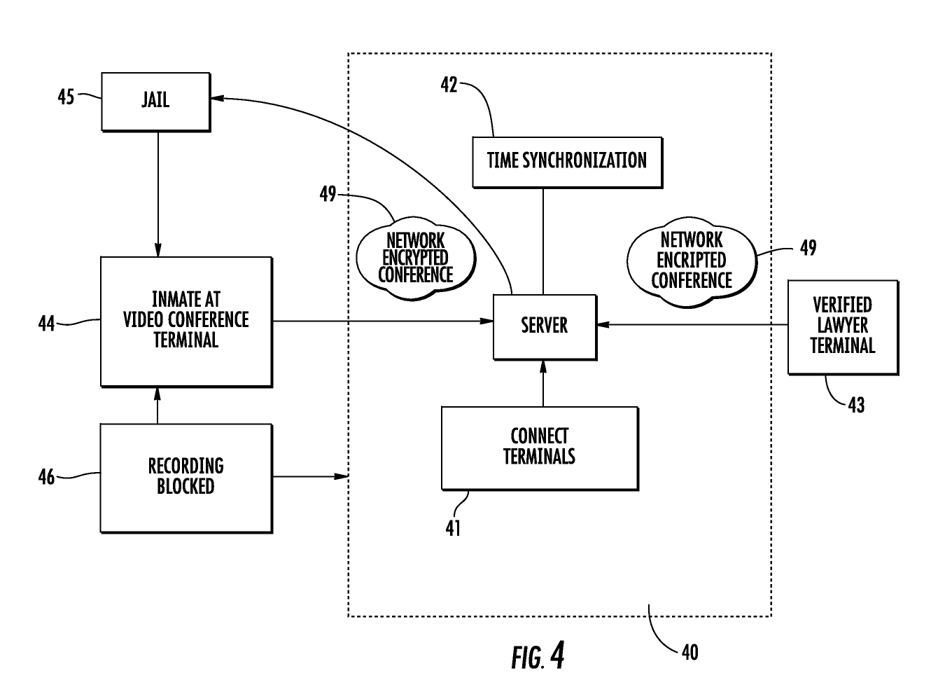

In FIG. 4 a depiction of the system for connecting the attorney and the inmate is depicted. The server 40 is depicted in this view with some of its functions noted during the video conference. The server comprises a time synchronization function 42 such that the layer terminal 43 and conference terminal 44 can be connected via the server 40 connection over the internet via an encrypted conference. The server connects 41 the two terminals together during the conference. The time synchronization and server 42 also notifies the jail 45 such that the inmate 44 is brought to the conference terminal for the video conference 49. A recoding blocking function 46 is also on the conference terminal 44. The recording blocking 46 function prevents both the server 40 or the conference terminal from recording the conference 49 and leaves only the lawyer 43 if desired to be recording the conference.

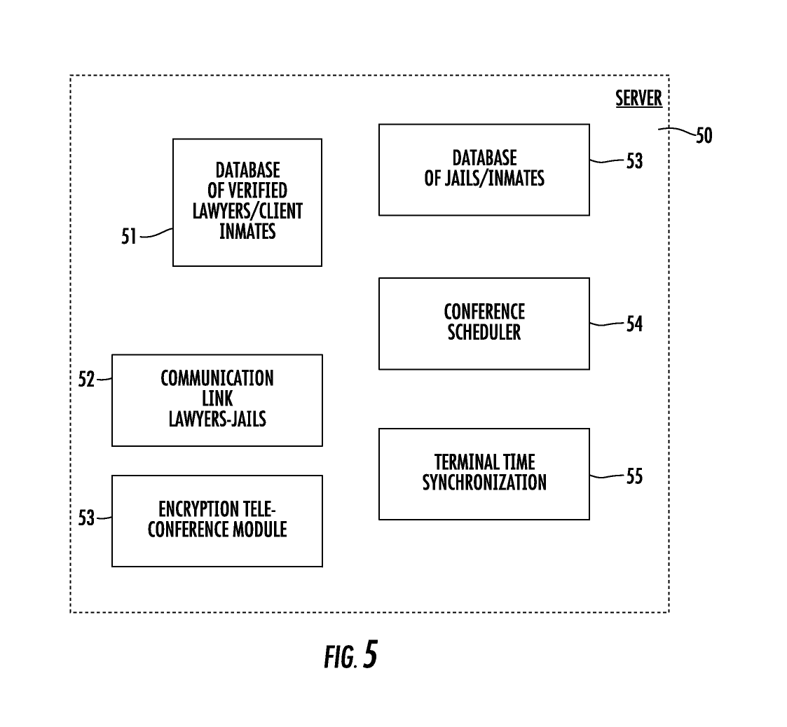

In FIG. 5 there is an example of a server 50 of the present invention with a number of functions on the server 50. In one function, a database of verified lawyers and client/inmates 51 is contained on the server 50. The database 51 is collected by verifying the attorneys and determining who their clients are and that they are inmates at particular institutions or locations. The database 51 can be automatically or manually entered on the database and is used to help with verification and making sure only authorized people are utilizing the server's 50 video conferencing services. The server 50 also comprises a communication link between the lawyers and jails 52. The communication link insures that appropriate communications (e.g. e-mails) between all the parties are made. This can be utilized when the jail needs to be notified of a schedule conference or perhaps notification of a lawyer when the conference needs to be cancelled or rescheduled. Within that communication module 52 or as a separate module is an encryption teleconference module 53. The module 53 establishes a video conference in an encrypted manner so that only the two parties can participate or view the conference.

FIG. 5 also shows an embodiment wherein there is a database of jails and of inmates 53. Once the jail or inmates are in the system, the database 53 can keep track of the jails and inmate names available to the system. The server 50 can then match jails inmates and lawyers in a manner necessary for a video conference. This is especially important when the conference scheduler 54 is operated. The conference scheduler 54 keeps track of the available times and dates for a conference and accesses the databases 51 and 53 to match their personnel and locations and attorneys with a date and time for a video conference. Because there is a need for the attorney computer, the jail, and the conference terminal at the jail to be operating at the same time to prevent multiple conference problems the server can also have a terminal time synchronization function 55. This function attempts to make sure that the parties to the conference and the jail each are operating on the same time (e.g. both attorney and inmate arrive at 10:00am for the conference). This can be done by adjusting the clocks on all the terminals or sending messages with the server's time or the like such that all parties know what time the server operates on.

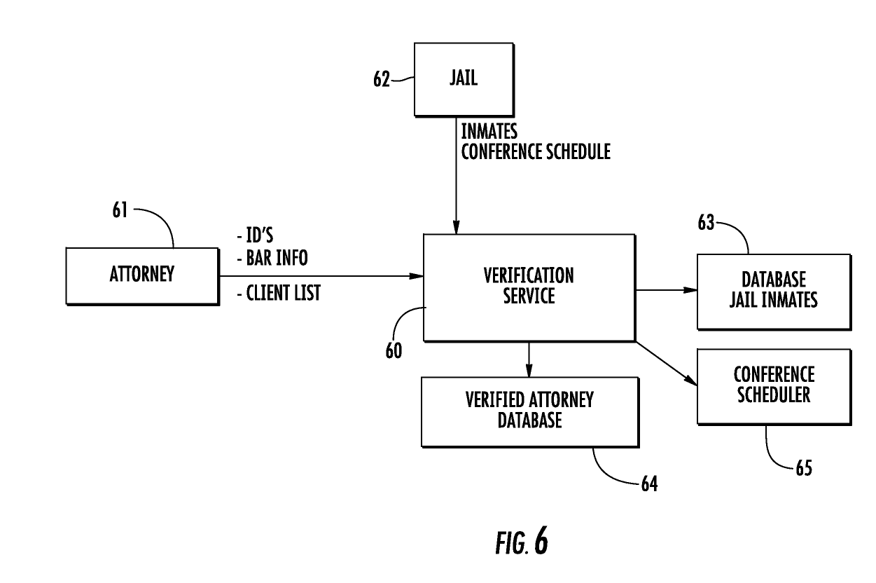

In FIG. 6 there is a diagram of the relationship of the verification service that allows only the inmate's attorney to participate in the video conference. While the system will accommodate multiple attorneys, jails, and clients, for simplicity, one lawyer and jail is depicted. The verification service is designed to make sure that an attorney accessing the system of the present invention is licensed and supposed to be representing a specific given inmate or not. The attorney 61 provides proof that the attorney is licensed, such as bar info, ID's, and the like, including letters of good standing and also provides a list of one or more clients that the attorney will be using the system with, along with proof that they are clients such as engagement agreements or the like which is reviewed and accepted or not by the verification service 60. The verification service then adds the name and information of the verified attorney to the verified attorney database 64 for reference by the server. Either the verification service or the server can then assign the pass codes or ID's for signing onto the system and keeping the conference confidential and allowing the attorney 61 to set up conferences. Likewise, the jail 62 provides the verification service information of their inmates that match with verified attorneys, as well as the schedule that the jail is willing to make inmates available to their attorneys. The verification service 60, either before or after the above, gives the jails and inmates identity to the server to create a database of jails and their inmates, and gives the available dates and times to the servers conference scheduler to allow the attorney 61 to sign up for a conference with their client.

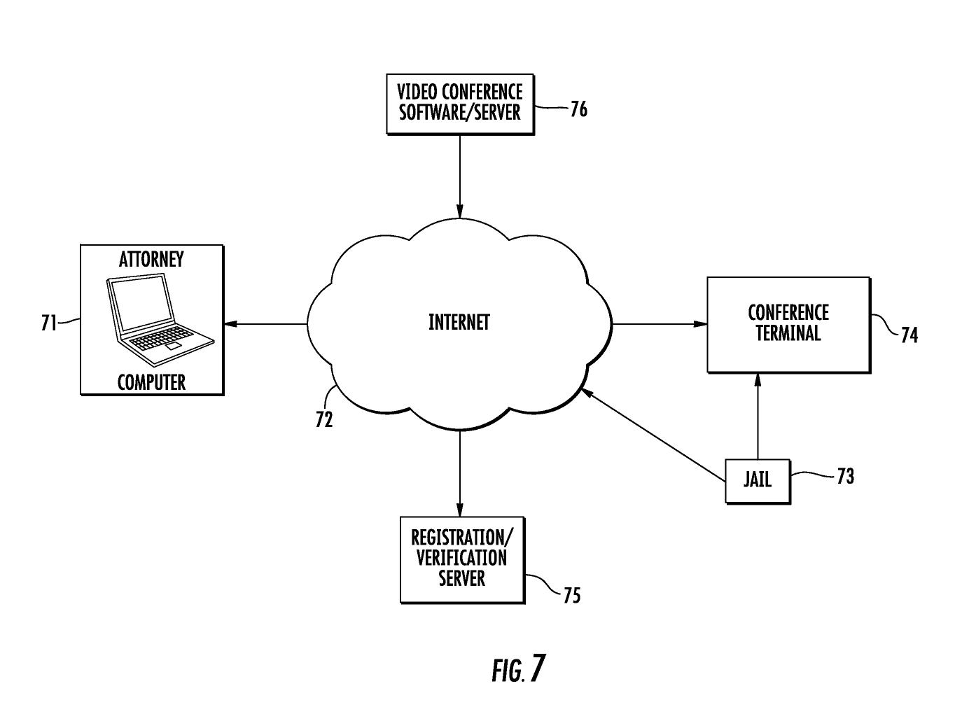

In FIG. 7 there is shown a block diagram with two separate servers (clearly any number of servers could be used). It is clear that each function requiring a server can be on a separate server or all on the same server as desired. Where the video conference software is provided by a third party vendor, FIG. 7 is a likely arrangement of servers, the internet, and video conference. In FIG. 7 attorney computer 71 has access to the internet 72 at any location desired. While computer 71 is depicted as portable, it can be any kind of computer, portable or not. Jail 73 has control over an incarcerated inmate and jail conference terminal 74. Jail personnel will bring an inmate to terminal 74 for a conference. In this embodiment, the registration and verification is a server 75 which has an internet 72 connection. Second server 76, also connected to internet 72, has video conference software that is confidential. Attorney is verified and signs into server 75 which then authorizes server 76 to engage attorney and inmate in a video conference.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method for conducting a confidential privileged video conference at a selected time between an incarcerated inmate at a specific video conference terminal at the incarceration location and the inmate's attorney located at a computer at an independent location comprising:
a) establishing a server to securely link the conference terminal and the computer over a communication network;
b) verifying the lawyers status and identity;
c) verifying the inmate is the attorney's client;
d) assigning an identity code for the attorney to sign into the server using the computer over the communication network;
e) establishing one or more people responsible to bring the inmate to the conference terminal at the selected time;
f) the attorney signing into the server while the inmate is brought to the terminal by the one or more people at the selected time;
g) the server establishing an encrypted link between the terminal and the computer at the selected time; and
h) the attorney and inmate conducting a confidential video conference.

2. The method according to claim 1 wherein the conference terminal is selected to only connect to the server.

3. The method according to claim 1 wherein at least one of the conference terminal is configured to not save any information of a video conference.

4. The method according to claim 1 wherein the server contacts the one or more people directly or indirectly to identify the inmate and the selected time of the video conference.

5. The method according to claim 1 wherein the server excludes links to any video conference device other than the computer and the video conference terminal.

6. The method according to claim 1 wherein the computer maintains a record of the video conference.

7. A system for conducting a confidential privileged video conference between an inmate incarcerated at a specific incarceration location and a verified attorney at a computer positioned at an independent location comprising:
a) a video conference terminal at the specific incarceration location;
b) a first server connected to a communications network designed to provide encrypted communication between the video conference terminal and the computer;
c) a verification service on a second server for communicating with the attorney on the computer; verifying the attorney and connecting the computer to the video conference terminal via the first server;
d) a scheduling service on a third server comprising a database of available conference times, a network interface for selecting a date and time for the video conference and a timer for starting the teleconference; and
e) a system for notifying at least one selected person at the incarceration location of the date and time of the conference for the purpose of bringing the inmate to the video conference terminal to participate in the conference.

8. The system according to claim 7 wherein there are a plurality of computers, attorneys, inmates, and prisons.

9. The system according to claim 7 wherein there is a verification code necessary for either the inmate or the attorney or both to access the video conference.

10. The system according to claim 7 wherein the video conference terminal is configured such that it cannot keep a digital record of a video conference.

11. The system according to claim 7 wherein the scheduling service further comprises the ability to automatically end the teleconference.

12. The system according to claim 7 wherein there are two or more servers.

13. A method for verifying an attorney for participating in a confidential privileged video conference between an incarcerated inmate at a video conference terminal at an incarceration location and the attorney at a computer located at an independent location comprising:
a) assembling an encrypted video conference system between the terminal and the computer;
b) assigning an attendant to manage the attorney verification;
c) the attorney providing proof of attorney status, proof of identity and proof that the inmate is the attorney's client to the attendant; and
d) the attendant issuing an access code to the attorney for accessing the encrypted video conference system.

14. The method according to claim 13 wherein there is an access code issued to the attorney for each conference.

15. The method according to claim 13 wherein there is an access code issued to the attorney for each inmate.

16. The method according to claim 13 wherein there are one or more servers connected to the internet that are managing the video conference.
